(19) United States
(12) Patent Application Publication
(10) Pub. No.: US 2017/0050297 A1
(43) Pub. Date: Feb. 23, 2017

(54) OPEN END WRENCH AND METHOD FOR MAKING THE SAME

(71) Applicant: Jia-Guann Liau, Taichung (TW)

(72) Inventor: Jia-Guann Liau, Taichung (TW)

(21) Appl. No.: 14/828,539

(22) Filed: Aug. 18, 2015

(51) Int. Cl. B25B 13/08; B25B 13/04

(52) U.S. Cl. CPC B25B 13/08; B25B 13/04

(57) ABSTRACT

A method for making an open end wrench includes preparing a body made of metal and the body having a handle and a driving portion which has a U-shaped open end. The driving portion has a first layer and a second layer which protrudes from the top and the bottom of the first layer. The front portion of each of the first and second layers extends along the open end. The rear portion of the first layer is connected to the first end of the handle. A first surface treatment is applied to the handle and the first and second layers to form a first decoration layer. The first decoration layer on the second layer is then removed by way of grinding. A second surface treatment is applied to the second layer to form a second decoration layer which has different visual effect from the first decoration layer.

### BACKGROUND OF THE INVENTION

1. Fields of the Invention

The present invention relates to an open end wrench and a method for making the same.

2. Descriptions of Related Art

The conventional open end wrench is disclosed in U.S. Pat. No. 2,687,056, and made by the method of forging. The surfaces of the open end wrench is then treated with one treatment such as electro-coating, printing, coloring, painting, rolling or vibration treatment so as to have a decoration surface formed on the driving head and the handle. However, there is only one treatment applied and the surface decoration is boring and not attractive.

The present invention intends to provide an open end wrench and a method for making the same, the present invention provides multiple detection surfaces so as to eliminate the shortcomings mentioned above.

### SUMMARY OF THE INVENTION

The present invention relates to a method for making an open end wrench, and comprises a body made of metal is prepared. The body has a handle and a driving portion which connected to the handle. The driving portion has an open end which is an U-shaped open end. The driving portion has a first layer and a second layer which protrudes from the top and the bottom of the first layer. The front portion of the first layer and the front portion of the second layer respectively extend along the open end. The rear portion of the first layer is connected to the first end of the handle. A first surface treatment is applied to the handle and the first and second layers of the driving portion to form a first decoration layer. The first decoration layer on the second layer is then removed by way of grinding, and a second surface treatment is applied to the second layer to form a second decoration layer which has different visual effect from the first decoration layer. The first and second surface treatments are two different treatments.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the open end wrench of the present invention;

FIG. 2 is a top view of the open end wrench of the present invention;

FIG. 3 is a side view of the open end wrench of the present invention;

FIG. 4 shows the steps of the method of the present invention;

FIG. 5 is a perspective view to show the open end wrench of the present invention;

FIG. 6 is a perspective view to show the second embodiment of the open end wrench of the present invention;

FIG. 7 is a perspective view to show the third embodiment of the open end wrench of the present invention;

FIG. 8 is a top view of the fourth embodiment of the open end wrench of the present invention;

FIG. 9 is a side view of the fourth embodiment of the open end wrench of the present invention;

FIG. 10 is a top view of the fifth embodiment of the open end wrench of the present invention;

FIG. 11 is a perspective view to show the sixth embodiment of the open end wrench of the present invention;

FIG. 12 is a top view of the sixth embodiment of the open end wrench of the present invention, and

FIG. 13 is a side view of the sixth embodiment of the open end wrench of the present invention.

### DETAILED DESCRIPTION OF THE PREFERRED EMBODIMENT

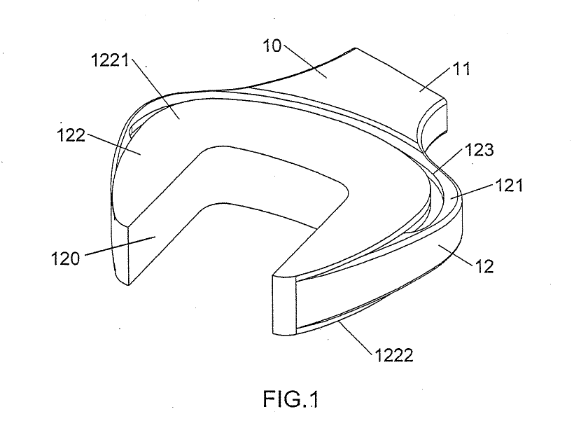

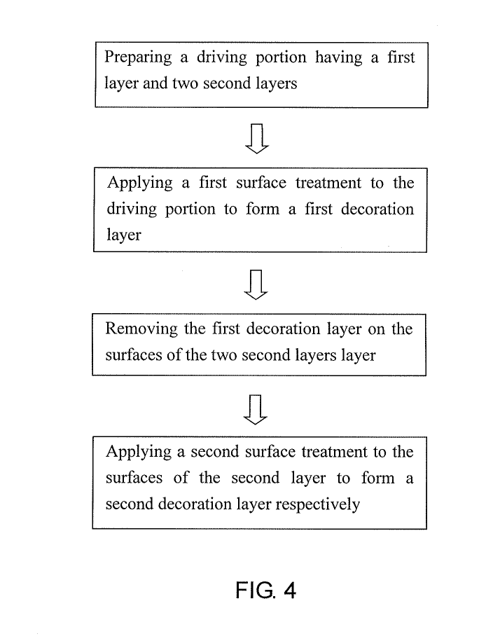

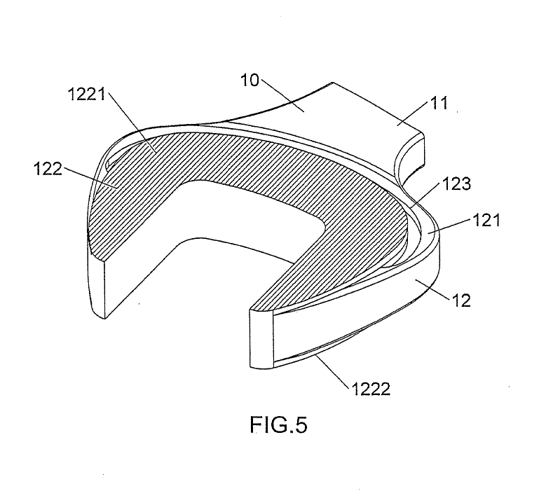

Referring to FIGS. 1 to 4, the open end wrench of the present invention comprises a body 10 made of metal is prepared, the body 10 has a handle 11, and a driving portion 12 is connected to the first end of the handle 11 and has an open end 120 which is a U-shaped open end. The driving portion 12 has a first layer 121, two second layers 122 which respectively protrude from the top and the bottom of the first layer 121, and two U-shaped recesses 123. The front portion of the first layer 121 and the front portion of the second layer 122 respectively extend along the open end 120. The rear portion of the first layer 121 is connected to the first end of the handle 11. A distance is formed between the rear portion of the second layer 122 and the first end of the handle 11. The biggest cross sectional area of the second layer 122 along a horizontal plane is smaller than that of the first layer 121 along another horizontal plane. One U-shaped recess 123 is formed between the rear portion of one second layer 122 and the top of the first layer 121, and the other U-shaped recess 123 is formed between the rear portion of the other second layer 122 and the bottom of the first layer 121, so as to reduce the weight of the driving portion 12 and increase the durable ability of the driving portion 12.

A first surface treatment is applied to the handle 11 and the first and second layers 121, 122 of the driving portion 12 to form a first decoration layer. The first surface treatment is one of fog-surface treatment, mirror-surface treatment, electro-coating, darkening, Nickel-coating, Chrome-coating, Tin-coating, Titanium-coating, electro-coloring, painting, color-brushing, printing and transfer printing. The first decoration layer on the surfaces 1221, 1222 of the two second layers 122 are then removed by using a grinding device 40. A second surface treatment is applied to the surfaces 1221, 1222 of the second layer 122 to form a second decoration layer respectively which has different visual effect from the first decoration layer. The first and second surface treatments being two different treatments. The second surface treatment is one of fog-surface treatment, mirror-surface treatment, electro-coating, darkening, Nickel-coating, Chrome-coating, Tin-coating, Titanium-coating, electro-coloring, painting, color-brushing, printing and transfer printing. The fog-surface treatment, the mirror-surface treatment and the electro-coating create a metallic surface effect on the body 10. The darkening, Nickel-coating, Chrome-coating, Tin-coating, Titanium-coating, electro-coloring, painting, color-brushing, printing and transfer printing create a surface color that is different from the original color of the metallic body 10. The thickness of the front portion of the first layer 121 is thicker than the thickness of the handle 11, and the thickness of the rear portion of the first layer 121 is the same as the thickness of the handle 11. An angle 33 of 2 to 7 degrees is defined between the top and bottom of the first layer 121. Preferably, the angle 33 is 4.84 degrees. A first distance 31 is defined between the top of the two second layers 122 on the top and bottom of the first layer 121, wherein the top of the two second layers 122 are parallel to each other. The thickness of the second layer 122 is the same of the maximum thickness of the first layer 121.

The open end 120 of the driving portion 12 includes two clamping insides 1201, and an imaginary line 1202 is connected between the two respective bottoms of the two clamping insides 1201. An imaginary bi-sectional line 124 extends through the middle point 1203 of the imaginary line 1202. The two clamping insides 1201 are located symmetrically to the imaginary bi-sectional line 124. An imaginary longitudinal line 125 extends through the middle point 1203 and is parallel to the central line 126 of the handle 11. The imaginary bi-sectional line 124, the imaginary longitudinal line 125 and the central line 126 of the handle 11 are located on the same horizontal plane. A shift distance 32 of 2 to 7 mm is formed between the imaginary longitudinal line 125 and the central line 126 of the handle 11. Preferably, the shift distance 32 is 5 mm. The angle between the imaginary bi-sectional line 124 and the imaginary longitudinal line 125 is 15 degrees.

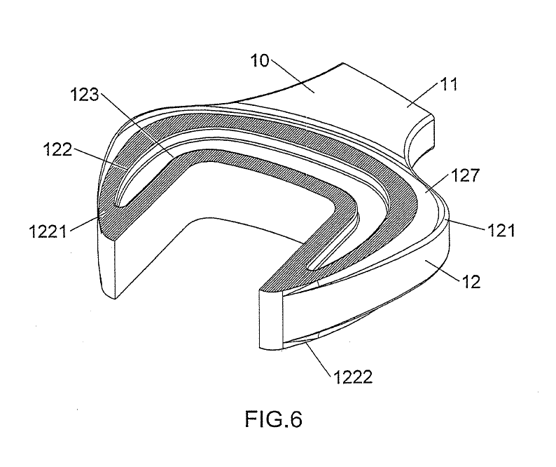

As shown in FIG. 6, a third layer 127 is formed between the rear portion of the second layer 122 and the first layer 121, and the top of the third layer 127 is a rounded top. The recess 123 is formed in the top of the second layer 122 and extends in a U shape.

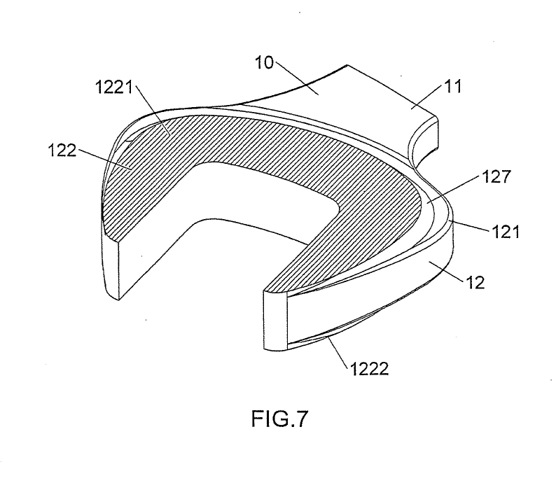

As shown in FIG. 7, a third layer 127 is formed between the rear portion of the second layer 122 and the first layer 121, and the top of the third layer 127 is a rounded top.

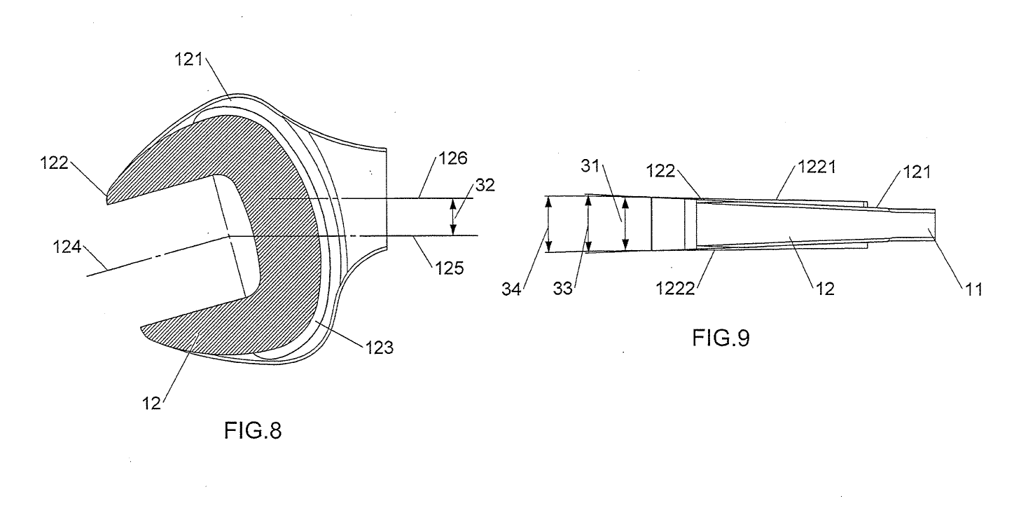

FIGS. 8 and 9 show that the thickness of the front portion of the second layer 122 is thicker than the thickness of the rear portion of the second layer 122. An angle 34 of 1.76 degrees is defined between the surface 1221 and 1222 of the second layers 122. The angle 34 is smaller than the angle 33 defined between the top and bottom of the first layer 121.

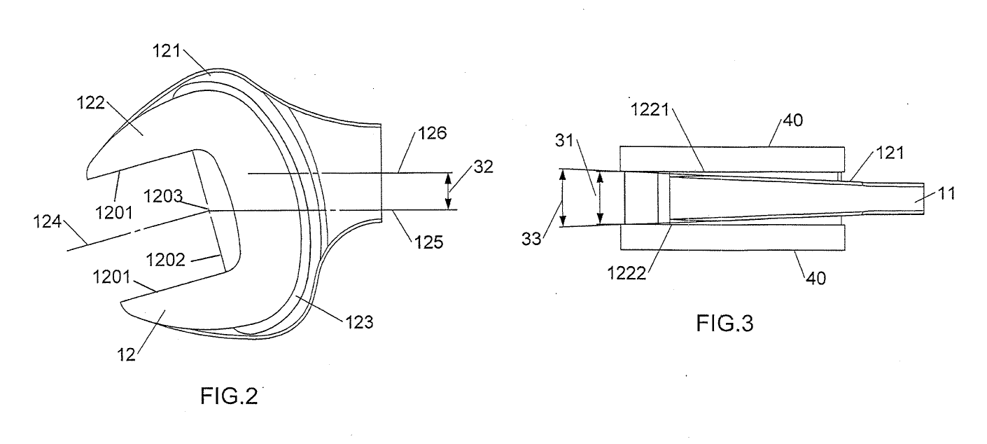

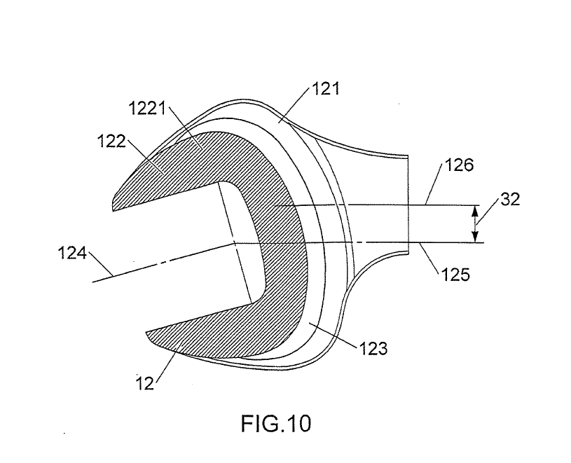

FIG. 10 shows that the cross sectional area of the second layer 122 on a horizontal plane is smaller than the cross sectional area of the second layer 122 on the same horizontal plane in FIG. 2.

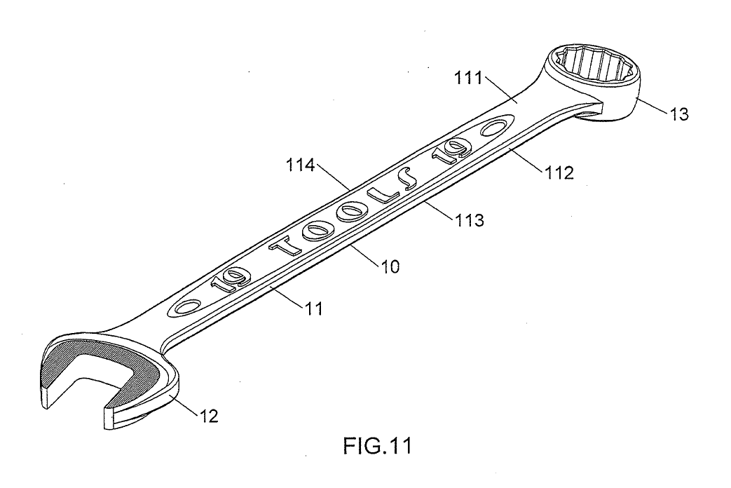

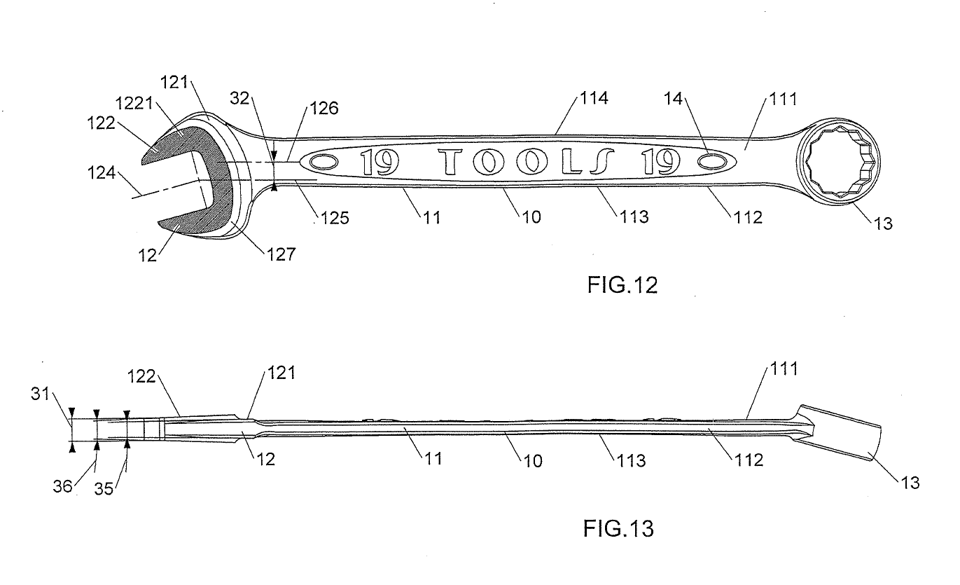

FIGS. 11 to 13 show that the handle 11 has a first face 111, a second face 112, a third face 113 and a fourth face 114. The first and third faces 111, 113 are located opposite to each other, and the second and fourth faces 112, 114 are located opposite to each other. The width of each of the first and third faces 111, 113 is wider than that of each of the second and fourth faces 112, 114. The first face 111 has at least one recessed area 15 which includes an index portion 16 protruding from an inner end thereof. The index portion 16 includes characters, patterns, specifications, sizes indications or trademarks. The top of the index portion is in flush with the first face 111. The handle 11 has a through hole 14. The handle 11 has a closed end 13 formed on the second end thereof. The thickness of the rear portion of the first layer 121 is thicker than that of the front portion of the first layer 121. An angle 35 of 1 to 5 degrees is defined between the top and bottom of the first layer 121. Preferably, the angle 35 is 1.6 degrees. The thickness of the rear portion of each of the second layers 122 is thicker than that of the front portion of each of the second layers 122. An angle 36 of 2 to 6 degrees is defined between the surfaces 1221, 1222. Preferably, the angle 36 is 3.89 degrees.

The recesses 123 of the driving portion 12 is provided for filling with colorful plastic as shown in FIG. 1.

While we have shown and described the embodiment in accordance with the present invention, it should be clear to those skilled in the art that further embodiments may be made without departing from the scope of the present invention.

What is claimed is:

1. A method for making an open end wrench, comprising:
preparing a body, the body being made of metal and having a handle, a driving portion connected to a first end of the handle and having an open end which is an U-shaped open end, the driving portion having a first layer and a second layer which protrudes from a top and a bottom of the first layer, a front portion of the first layer and a front portion of the second layer respectively extending along the open end, a rear portion of the first layer connected to the first end of the handle;
applying a first surface treatment to the handle and the first and second layers of the driving portion to form a first decoration layer;
removing the first decoration layer on a surface of the second layer, and
applying a second surface treatment to the surface of the second layer to form a second decoration layer which has different visual effect from the first decoration layer, the first and second surface treatments being two different treatments.

2. The method as claimed in claim 1, wherein the first surface treatment is one of fog-surface treatment, mirror-surface treatment, electro-coating, darkening, Nickel-coating, Chrome-coating, Tin-coating, Titanium-coating, electro-coloring, painting, color-brushing, printing and transfer printing.

3. The method as claimed in claim 1, wherein the first surface treatment is a darkening treatment, the second surface treatment is a paining treatment, the painting treating paints clear paint.

4. The method as claimed in claim 1, wherein the first surface treatment is a mirror treatment, the second surface treatment is a transfer printing treatment.

5. The method as claimed in claim 1, wherein a distance is formed between a rear portion of the second layer and the first end of the handle, a U-shaped recess is formed between each of a top and a bottom of the rear portion of the second layer and the first layer.

6. The method as claimed in claim 1, wherein a U-shaped recess is formed in a top of the second layer, a third layer is formed between a rear portion of the second layer and the first layer, a top of the third layer is a rounded top.

7. The method as claimed in claim 1, wherein a thickness of the front portion of the first layer is thicker than a thickness of the rear portion of the first layer, the thickness of the front portion of the first layer is the same as a thickness of the handle, an angle of 2 to 7 degrees is defined between the top and bottom of the first layer.

8. The method as claimed in claim 7, wherein the angle is 4.84 degrees.

9. The method as claimed in claim 7, wherein a thickness of the second layer is the same of a maximum thickness of the first layer, a first distance is defined between the top and bottom of the second layer, the top and the bottom of the second layer are parallel to each other.

10. The method as claimed in claim 1, wherein an angle of 1.76 degrees is defined between a top and a bottom of the second layer.

11. An open end wrench comprising:
a body made of metal and having a handle, a driving portion connected to a first end of the handle and having an open end which is an U-shaped open end, the driving portion having a first layer and a second layer which protrudes from a top and a bottom of the first layer, a front portion of the first layer and a front portion of the second layer respectively extending along the open end, a rear portion of the first layer connected to the first end of the handle;
a thickness of the rear portion of the first layer being larger than a thickness of the front portion of the first layer, an angle of 1 to 5 degrees being defined between the top and the bottom of the first layer, a distance being formed between a rear portion of the second layer and the first end of the handle, a thickness of the rear portion of the second layer being larger than a thickness of the front portion of the second layer, an angle of 2 to 6 degrees being defined between a top and a bottom of the second layer.

12. The wrench as claimed in claim 11, wherein the angle between the top and the bottom of the first layer is 1.6 degrees, the angle between the top and the bottom of the second layer is 3.89 degrees.

13. The wrench as claimed in claim 11, wherein the open end of the driving portion includes two clamping insides, an imaginary line is connected between the two respective bottoms of the two clamping insides, an imaginary bi-sectional line extends through a middle point of the imaginary line, the two clamping insides are located symmetrically to the imaginary bi-sectional line, an imaginary longitudinal line extends through the middle point and is parallel to the central line of the handle, a shift distance of 2 to 7 mm is formed between the imaginary longitudinal line and the central line of the handle.

14. The wrench as claimed in claim 13, wherein the shift distance is 5 mm.

15. The wrench as claimed in claim 11, wherein the handle has a first face, a second face, a third face and a fourth face, the first and third faces are located opposite to each other, and the second and fourth faces are located opposite to each other, a width of each of the first and third faces is wider than that of each of the second and fourth faces, the first face has at least one recessed area which includes an index portion protruding from an inner end thereof, the index portion includes characters, patterns, specifications, sizes indications or trademarks, a top of the index portion is in flush with the first face.

16. The wrench as claimed in claim 11, wherein the handle has a closed end formed on a second end thereof.

17. The wrench as claimed in claim 11, wherein the driving portion has a recess in which colorful plastic is filled.
